(19) United States
(12) Patent Application Publication
(10) Pub. No.: US 2007/0277518 A1
(43) Pub. Date: Dec. 6, 2007

(54) Hydrodynamic torque converter

(75) Inventors: Georg Mencher, Grafenrheinfeld (DE); Gregor Sueck, Sennfeld (DE); Christoph Sasse, Schweinfurt (DE); Peter Frey, Gerolzhofen (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/803,955

(22) Filed: May 16, 2007

(30) Foreign Application Priority Data
Jun. 3, 2006 (DE) 10 2006 026 079.1

(51) Int. Cl. F16D 33/00

(52) U.S. Cl. 60/361

(57) ABSTRACT

A hydrodynamic torque converter includes a pump wheel with a plurality of pump wheel vanes arranged in a row in the circumferential direction around an axis of rotation; a turbine wheel, which can rotate relative to the pump wheel around the axis of rotation and which has a plurality of turbine wheel vanes arranged in a row in the circumferential direction around the axis of rotation; and a stator with a plurality of stator vanes arranged in a row in the circumferential direction around the axis of rotation. The pump wheel, the turbine wheel, and the stator define a hydrodynamic circuit with an outside diameter Dₐ, an inside diameter Dᵢ, and a maximum axial length Lₐ, where (1) Dᵢ/Dₐ<0.58 and (2) Dₐ⁵≦5.2⁻¹×10¹⁰×M, where M is the maximum torque in Nm to be transmitted via the hydrodynamic torque converter, and Dₐ is the outside diameter of the hydrodynamic circuit in mm.

### BACKGROUND OF THE INVENTION

1. Field of the Invention

The present invention pertains to a hydrodynamic torque converter, including a pump wheel with a plurality of pump wheel vanes arranged in a row in the circumferential direction around an axis of rotation; a turbine wheel, which can rotate relative to the pump wheel around the axis of rotation and which has a plurality of turbine wheel vanes arranged in a row in the circumferential direction around the axis of rotation; and a stator with a plurality of stator vanes arranged in a row in the circumferential direction around the axis of rotation.

2. Description of the Related Art

A hydrodynamic torque converter of this type is known from, for example, EP 0 070 662 A1. In this hydrodynamic torque converter, the ratio of the inside diameter of the hydrodynamic circuit to its outside diameter is greater than 0.5 to obtain high efficiency and to decrease the overall axial length of the hydrodynamic torque converter, especially in cases where the converter is also to be equipped with a bridging clutch. In addition, the ratio of the radial height of the hydrodynamic circuit, that is, the difference between the outside radius and the inside radius of the circuit, to the maximum axial length should not be greater than 1 and is preferably less than 1.

### SUMMARY OF THE INVENTION

Against the background of this type of known hydrodynamic torque converter, the goal of the present invention is to provide a hydrodynamic torque converter which, under consideration of the amount of torque to be transmitted, occupies the least possible amount of space.

According to the invention, the pump wheel, the turbine wheel, and the stator define a hydrodynamic circuit with an outside diameter Dₐ, an inside diameter Dᵢ, and a maximum axial length Lₐ, where the following are true for the hydrodynamic circuit:

Dᵢ/Dₐ<0.58 (1)

and

Dₐ⁵≦5.2⁻¹×10¹⁰×M, (2)

where M is the maximum torque in Nm to be transmitted via the hydrodynamic torque converter, and Dₐ and Dᵢ are in mm.

By specifying the upper limit for the ratio of the inside diameter to the outside diameter of the hydrodynamic circuit, which, of course, corresponds to the ratio of the inside radius to the outside radius of this hydrodynamic circuit, and also an upper limit for the outside diameter of the hydrodynamic circuit as a function of the maximum amount of torque to be transmitted, a hydrodynamic circuit is, under consideration of this maximum amount of torque to be transmitted, provided with geometric boundary conditions which make it possible for the circuit reliably to transmit this maximum torque, which can be the maximum torque generated by a drive assembly, without at the same time exceeding certain structural upper limits.

For example, the outside diameter Dₐ of the hydrodynamic circuit can be in the range of 220-290 mm.

It has also been found that, under consideration of the previously mentioned dimensions of the hydrodynamic torque converter, it is especially advantageous for the difference between half the outside diameter Dₐ and half the inside diameter Dᵢ to correspond essentially to the maximum axial length Lₐ.

The present invention also pertains to a drive system for a vehicle, including a drive assembly and a hydrodynamic torque converter built according to the invention, where the maximum torque M to be transmitted via the hydrodynamic torque converter corresponds to the maximum drive torque of the drive assembly.

Other objects and features of the present invention will become apparent from the following detailed description considered in conjunction with the accompanying drawing. It is to be understood, however, that the drawing is designed solely for purposes of illustration and not as a definition of the limits of the invention, for which reference should be made to the appended claims. It should be further understood that the drawing is not necessarily drawn to scale and that, unless otherwise indicated, they are merely intended to conceptually illustrate the structures and procedures described herein.

### BRIEF DESCRIPTION OF THE DRAWINGS

The sole FIGURE is a longitudinal cross section through a hydrodynamic torque converter fulfilling the principles of the present invention.

### DETAILED DESCRIPTION OF THE PRESENTLY PREFERRED EMBODIMENTS

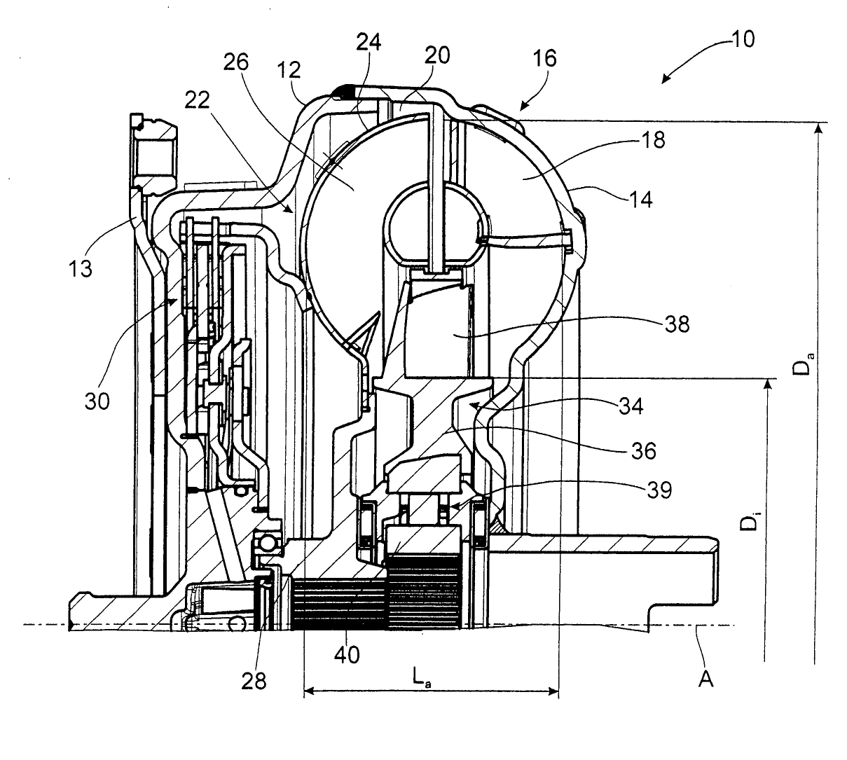

FIG. 1 shows a hydrodynamic torque converter 10, which includes a housing 12 as the input area, which can be connected by a coupling arrangement 13 for rotation in common around an axis of rotation A to a drive shaft of a drive assembly. To complete the housing 12, a pump wheel outer shell 14 of a pump wheel 16 is connected to it, where a plurality of pump wheel vanes 18 arranged in a row in the circumferential direction is provided on the interior side of the pump wheel outer shell 14. In the interior space 20 surrounded by the housing 12 and the pump wheel outer shell 14, a turbine wheel 22 is installed, which carries a plurality of turbine wheel vanes 26 arranged in a row in the circumferential direction on the turbine wheel outer shell 24. The turbine wheel outer shell 24 is connected to a turbine wheel hub 28, so that it can transmit the torque received from the turbine wheel 22 to a takeoff element (not shown), such as a gearbox input shaft. The turbine wheel hub 28 can also be connected by a bridging clutch arrangement 30 and possibly also by a torsional vibration damper arrangement (not shown) to the housing 12, so that a direct mechanical torque-transmitting connection is created between the housing and thus the drive shaft on one side and the turbine wheel hub 28 and thus the takeoff shaft on the other side.

In the radially inner area, between the pump wheel 16 and the turbine wheel 22, a stator 34 is provided. This carries a plurality of stator vanes 38 on its outer ring 36. The vanes are located between the radially inner and axially opposing ends of the pump wheel vanes 18 and the turbine wheel vanes 26. The outer stator ring 36 is carried by way of a freewheel arrangement 39 and a stator hub 40 on a support element (not shown) and thus is able to rotate in one direction around the axis of rotation A, whereas the stator 34 is unable to rotate in the opposite direction.

The interior space 20 is filled with fluid, so that, in the known manner, a hydrodynamic circuit is formed by the pump wheel 16, the turbine wheel 22, and the stator 34 during rotational operation. The circuit extends through the ring-like torus limited primarily by the pump wheel outer shell 14, the turbine wheel outer shell 24, and the stator outer ring 36. The geometries of the pump wheel 16, the turbine wheel 22, and the stator 34 define the various dimensions of this hydrodynamic circuit. Thus, the radially outer ends of the turbine wheel vanes 26 and of the pump wheel vanes 18 essentially define the outside diameter Dₐ of the hydrodynamic circuit, whereas the corresponding radially inner ends of these vanes 18, 26 and of the stator vanes 38 define the inside diameter Dᵢ of this hydrodynamic circuit. The outward convexities of the pump wheel outer shell 14 and of the turbine wheel outer shell 24 define the maximum axial length Lₐ of the hydrodynamic circuit

In a hydrodynamic torque converter designed in accordance with the invention, these dimensional values assume certain relationships. Thus, the following relationship is specified for the ratio between the inside diameter Dᵢ and the outside diameter Dₐ:

Dᵢ/Dₐ<0.58.

For a given outside diameter Dₐ, therefore, this corresponds to a maximum value of 0.58×Dₐ for the inside diameter Dᵢ.

The outside diameter Dₐ also fulfills the following condition:

Dₐ⁵≦5.2⁻¹×10¹⁰×M,

where the variable M corresponds to the maximum amount of torque or drive torque in Nm to be transmitted via this type of hydrodynamic torque converter 10, and the variable Dₐ, that is, the outside diameter of the hydrodynamic circuit, is expressed in mm.

Here, therefore, as a function of the maximum amount of torque to be transmitted, which, when this type of hydrodynamic torque converter 10 is integrated into a drive train, corresponds essentially to the maximum amount of torque put out by the drive assembly, such as an internal combustion engine, an upper limit is defined for the outside diameter Dₐ of the hydrodynamic circuit. It is thus ensured that, as a function of the maximum amount of torque to be transmitted, the outside diameter of the hydrodynamic circuit and therefore also the maximum outside dimension of the entire hydrodynamic torque converter will not exceed a certain maximum value, which, under consideration of the previously mentioned ratio of the inside diameter Dᵢ to the outside diameter Dₐ, leads to a very compact design of this type of hydrodynamic torque converter. A very compact design brings various advantages with it. For example, the total weight of a hydrodynamic torque converter of this type can be limited, which in turn offers advantages with respect to energy, i.e., fuel, consumption. In addition, the mass inertia is reduced, as a result of which much better driving behavior can be obtained, especially in vehicles with a sporty character. It must be taken into account in general that, because of the need to integrate various other assemblies into the available space and because of various other design considerations, there is usually only a very limited amount of space available in vehicles for the individual system components, which means that the inventive design is advantageous especially under consideration of the fact that the trend is to use increasingly more powerful and therefore generally also larger drive assemblies, which, of course, also take up more space.

The previously described conditions prove to be especially advantageous when, for example, the outside diameter of the hydrodynamic circuit is in the range of 220-290 mm. It is also especially advantageous for the hydrodynamic circuit to be a so-called “round” circuit, that is, a circuit in which the radial dimension, essentially defined by the difference between half the outside diameter Dₐ and half the inside diameter Dᵢ corresponds essentially also to the maximum axial length Lₐ.

It should also be pointed out that the hydrodynamic torque converter 10 can obviously be designed in various ways. This pertains in particular to the design of the bridging clutch arrangement, of the torsional vibration damper arrangement, and of the coupling of the turbine wheel to the bridging clutch arrangement or to the torsional vibration damper arrangement, and, of course, it also pertains to how the flow of fluid is guided inside the hydrodynamic torque converter. The hydrodynamic torque converter shown in FIG. 1 shows only one example, and it is obvious that the inventive rules governing its dimensions can also be fulfilled and/or can also prove to be advantageous in other types of designs.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. Hydrodynamic torque converter, comprising:
a pump wheel with a plurality of pump wheel vanes arranged in a row in the circumferential direction around an axis of rotation;
a turbine wheel, which can rotate relative to the pump wheel around the axis of rotation and which has a plurality of turbine wheel vanes arranged in a row in the circumferential direction around the axis of rotation; and
a stator with a plurality of stator vanes arranged in a row in the circumferential direction around the axis of rotation;
wherein the pump wheel, the turbine wheel, and the stator define a hydrodynamic circuit with an outside diameter Dₐ, an inside diameter Dᵢ, and a maximum axial length Lₐ, wherein
Dᵢ/Dₐ<0.58 (1)
and
Dₐ⁵≦5.2⁻¹×10¹⁰×M, (2)
wherein M is the maximum torque in Nm to be transmitted via the 16 hydrodynamic torque converter, and Dᵢ and Dₐ are in mm.

2. The hydrodynamic torque converter of claim 1 wherein the outside diameter Dₐ of the hydrodynamic circuit is in a range of 220-290 mm.

3. The hydrodynamic torque converter of claim 1 wherein the difference between half the outside diameter Dₐ and half the inside diameter Dᵢ is essentially the same as the maximum axial length Lₐ.

4. Drive system for a vehicle comprising a drive assembly and a hydrodynamic torque converter, wherein the hydrodynamic torque converter comprises:
a pump wheel with a plurality of pump wheel vanes arranged in a row in the circumferential direction around an axis of rotation;
a turbine wheel, which can rotate relative to the pump wheel around the axis of rotation and which has a plurality of turbine wheel vanes arranged in a row in the circumferential direction around the axis of rotation; and
a stator with a plurality of stator vanes arranged in a row in the circumferential direction around the axis of rotation;
wherein the pump wheel, the turbine wheel, and the stator define a hydrodynamic circuit with an outside diameter Dₐ, an inside diameter Dᵢ, and a maximum axial length Lₐ, wherein Dᵢ/Dₐ<0.58 and Dₐ⁵≦5.2⁻¹×10¹⁰×M;
wherein M is the maximum torque in Nm to be transmitted via the hydrodynamic torque converter, and Dᵢ and Dₐ are in mm;
wherein the drive assembly has a drive shaft which is or can be connected to the pump wheel of the hydrodynamic torque converter for rotation in common around the axis of rotation, and where the maximum amount of torque M to be transmitted via the hydrodynamic torque converter corresponds to the maximum amount of drive torque of the drive assembly.
